(19) United States
(12) Patent Application Publication
(10) Pub. No.: US 2011/0020642 A1
(43) Pub. Date: Jan. 27, 2011

(54) ADHESIVE COMPOSITION, ADHESIVE SHEET AND ADHESIVE FORMED PRODUCT

(75) Inventors: Shigeyuki Yaguchi, Tokyo (JP); Yoshitomo One, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignees: LINTEC; HONDA GIKEN KOGYO KABUSHIKI KAISHA

(21) Appl. No.: 12/934,111

(22) PCT Filed: Mar. 25, 2009
(86) PCT No.: PCT/JP2009/056770

§ 371 Date: Sep. 23, 2010

(30) Foreign Application Priority Data
Mar. 27, 2008 (JP) 2008-083527
Mar. 27, 2008 (JP) 2008-083529

(51) Int. Cl. B32B 7/12; H01F 1/00

(52) U.S. Cl. 428/355 AC; 252/62.51 R

(57) ABSTRACT

The present invention provides an adhesive composition, which comprises a mixture of a hot-melt adhesive with a ferromagnetic material and has a shear force of not less than 20 N after heating (at 150° C. for 10 minutes) bonding, and a adhesive sheet obtained from the adhesive composition. Also, present invention provides a adhesive formed product, which comprises a mixture of a hot-melt adhesive and a ferromagnetic material and has a shear force of not less than 20 N after heating (at 150° C. for 10 minutes) bonding, wherein the adhesive formed product is used for bonding between components composed of a material exhibiting ferromagnetism. The adhesive composition, the adhesive sheet and the adhesive formed product of the present invention can also be applied to fields where solvent resistance and chemical resistance are required.

### TECHNICAL FIELD

The present invention relates to an adhesive composition, an adhesive sheet and an adhesive formed product. Specifically, the present invention relates to the adhesive composition, the adhesive sheet and the adhesive formed product which can also be applied to fields where solvent resistance and chemical resistance are required.

### BACKGROUND ART

Conventionally, an adhesive sheet has been stuck on an article, or in order to bond between components, an adhesive sheet has been stuck to the surface of the components to be bonded to bond between the components.

There have been problems that if the adhesive sheet is positioned incorrectly to the location to be stuck in the initial stage of the sticking to an article, it is difficult to peel off from the incorrect location and stick to the correct location, or even if the peeling off and the sticking can be conducted, the adhesive residue is remained on the surface of the article. In addition, there has been a problem that when an adhesive sheet having a large area is stuck on an article, the workability is remarkably inferior, or it is difficult to stick the adhesive sheet on a surface of an article smeared with oil on the surface. Further, the adhesive sheet has an adhesion before sticking the adhesive sheet, and therefore, the adhesive sheet has been needed to cover the surface of adhesive layer with a release paper and when the adhesive sheet is used, the operation for peeling off and removing the release paper and the operation for throwing away the removed release paper have been needed.

In order to solve the problems, a method for attaching a damping material, a reinforcing material or the like used in automobiles by utilizing magnetic force has been proposed (see JP2006-315216 A1 and JP2006-315234 A1).

However, there have been problems that these methods have insufficient adhesion or it is inferior in solvent resistance or chemical resistance because each of the methods uses the rubber based adhesive.

On the other hand, as a method for reinforcing a thin steel plate used in doors of automobiles or the like, a method which comprises attaching a reinforcing sheet composed of a mixture of a rubber based synthetic resin, a magnetic powder and a foaming agent, to a prescribed location of the thin steel plate by means of magnetic force and holding temporarily, and then fusion bonding by heating, has been proposed (see JP2006-315234 A1).

However, the method is not a method for bonding between components, and there has been a problem that the method is not applicable to the bonding between components in which strong bonding is required, because the foaming agent is contained. Further, there has been a problem that it is inferior in solvent resistance or chemical resistance because of the rubber based synthetic resin.

### DISCLOSURE OF THE INVENTION

The present invention is provided as the result of considering the situation of the conventional technologies described above.

An object of the present invention is to provide an adhesive composition and a adhesive sheet which can be in a state of holding by means of magnetic force in initial stage of the sticking at room temperature (ordinary temperature) to an adherend (article) composed of a metal or the like, and therefore, can move easily and position easily to a correct location even if the positioning of the location to be stuck is incorrect, and does not cause the adhesive residue on the surface of the adherend, can increase the workability remarkably when the adhesive sheet having a large area is stuck, can hold by means of magnetic force also on a surface of an adherend smeared with oil or solvent on the surface, and can have a strong adhesion after heating.

Another object of the present invention is to provide an adhesive formed product which can hold the components to the prescribed location by means of magnetic force in initial stage of the bonding between components composed of a ferromagnetic material, can not almost have adhesion, can move easily and position easily to a correct location even if the positioning of the location to be stuck is incorrect, and does not cause the adhesive residue on the surface of the adherend, can not need the operation for peeling off and removing the release paper and the operation for throwing away the removed release paper, can be superior in the sticking application on a surface of an adherend smeared with oil or solvent on the surface, and can bond strongly between components composed of the ferromagnetic material.

The present inventors have perfected the present invention by discovering that the adhesive composition and the adhesive sheet comprise a mixture of a hot-melt adhesive and a ferromagnetic material, and have a shear force of not less than 20 N after heating (at 150° C. for 10 minutes) bonding, and the above-described problems can be solved by thereof.

That is to say, the present invention provides an adhesive composition, which comprises a mixture of a hot-melt adhesive and a ferromagnetic material, and has a shear force of not less than 20 N after heating (at 150° C. for 10 minutes) bonding.

Additionally, the present invention provides the adhesive composition as described above, wherein the adhesive composition has a viscosity of 5 to 500 Pa·s at 130° C.

Additionally, the present invention provides the adhesive composition as described above, wherein the hot-melt adhesive is a polyester resin based hot-melt adhesive or a polyolefin resin based hot-melt adhesive.

Further, the present invention provides an adhesive sheet which comprises the adhesive composition as described above and has a surface magnetic force of not less than 20 mT and a surface magnetic force after heating (at 150° C. for 40 minutes) of less than 5 mT.

Furthermore, the present invention provides the adhesive sheet as described above, wherein the adhesive sheet can be applied to a surface of an adherend smeared with oil on the surface.

Also, the present invention provides an adhesive sheet with a substrate which comprises a substrate sheet and a layer comprising the adhesive composition as described in any one of the above adhesive compositions, wherein the layer is laminated on one surface or both surfaces of the substrate sheet.

Further, the present invention provides an adhesive formed product, which comprises a mixture of a hot-melt adhesive and a ferromagnetic material, and has a shear force of not less than 20 N after heating (at 150° C. for 10 minutes) bonding, wherein the adhesive formed product is used for bonding between components composed of a material exhibiting ferromagnetism.

Additionally, the present invention provides the adhesive formed product as described above, wherein a shear force of the mixture after heating (at 150° C. for 10 minutes) bonding is not less than 50 N.

Additionally, the present invention provides the adhesive formed product as described above, wherein the mixture of the hot-melt adhesive and the ferromagnetic material has a viscosity of 5 to 500 Pa·s at 130° C.

Furthermore, the present invention provides the adhesive formed product as described above, wherein the adhesive formed product has a surface magnetic force of not less than 20 mT and a surface magnetic force after heating (at 150° C. for 40 minutes) of less than 5 mT.

The adhesive sheet having a layer comprising the adhesive composition of the present invention can be in a state of holding by means of magnetic force in initial stage of the adhesion at room temperature to an adherend (article) composed of a metal or the like, and also, can move easily and position easily to a correct location even if the positioning of the location to be stuck is incorrect, and does not cause the adhesive residue on the surface of the adherend, because the adhesive sheet almost does not have tack, can increase the workability remarkably when the adhesive sheet having a large area is stuck, can hold by means of magnetic force also on a surface of an adherend smeared with solvent such as oil or chemical on the surface, further can obtain a strong adhesion by heating, and can be used instead of a bolt or a screw as means of bonding.

The adhesive formed product of the present invention can hold the components to the prescribed location by means of magnetic force in initial stage of the bonding between components composed of a ferromagnetic material, can move easily and position easily to a correct location even if the positioning of the location to be stuck is incorrect, and does not cause the adhesive residue on the surface of the component, because the adhesive formed product does not almost have adhesion, can not need the operation for peeling off and removing the release paper and the operation for throwing away the removed release paper, can be superior in the sticking application on a surface of a component smeared with oil or solvent on the surface, further can obtain a strong adhesion by heating, and can be used instead of a bolt or a screw as means of bonding between components composed of the ferromagnetic material.

### BRIEF DESCRIPTION OF THE DRAWINGS

FIG. 1 shows a perspective view of a state for bonding a bored steel plate for automobile bodies and a steel plate for stopping up the hole by using an adhesive formed product of one embodiment of the present invention;

FIG. 2 shows a cross section view of a state in which a bored steel plate for automobile bodies and a steel plate for stopping up the hole were bonded by using an adhesive formed product of one embodiment of the present invention as shown in FIG. 1.

In drawings, 1 means an adhesive formed product, 2 means a steel plate for automobile bodies, 3 means a hole, 4 means a steel plate for stopping up the hole.

### PREFERRED EMBODIMENTS FOR CARRYING OUT THE INVENTION

The adhesive composition of the present invention comprises a mixture of a hot-melt adhesive and a ferromagnetic material.

The hot-melt adhesive is an adhesive which has no tack or has almost no tack at room temperature (ordinary temperature), but is softened by heating and generates adhesive property, and then is solidified by returning the heated hot-melt adhesive to the room temperature, and can adhere thereby.

The hot-melt adhesive includes a polyolefin resin based hot-melt adhesive and a polyester resin based hot-melt adhesive. Further, when the adhesive composition is applied to a surface of an adherend smeared with oil on the surface, the polyolefin resin based hot-melt adhesive is particularly preferable.

Examples of the polyolefin resin based hot-melt adhesive include a propylene-ethylene-butene-1 copolymer and an ethylene-vinyl acetate copolymer.

Examples of the polyester resin based hot-melt adhesive include a condensation polymer of a di-carboxyl acid ingredient and a diol ingredient. The di-carboxyl acid ingredient includes terephthalic acid, isophthalic acid and lower alkyl ester thereof, and malonic acid, succinic acid, adipic acid and sebatic acid. The diol ingredient includes ethylene glycol, 1,3-propane diol, 1,4-butane diol, 1,5-pentane diol, 1,6-hexane diol, diethylene glycol, triethylene glycol, polyethylene glycol, cyclohexane dimethanol, neopentyl glycol and polytetramethylene glycol. The polyester resin based hot-melt adhesive can be obtained by using each one or more members selected from these di-carboxyl acid ingredient and these diol ingredient.

The adhesive formed product of the present invention comprises a mixture of a hot-melt adhesive and a ferromagnetic material, like the adhesive composition of the present invention as described above.

As the hot-melt adhesive which can be used in the adhesive formed product of the present invention, the same adhesives as described above can be used, and a rubber based hot-melt adhesive can be also used except for the adhesives as described above. Among them, the polyolefin resin based hot-melt adhesive and the polyester resin based hot-melt adhesive are preferable, and the polyester resin based hot-melt adhesive are particularly preferable. If the adhesive formed product is applied on the surface of the component smeared with oil on the surface, the polyolefin resin based hot-melt adhesive are particularly preferable.

Examples of the rubber based hot-melt adhesive which can be used in the adhesive formed product of the present invention, include rubber based hot-melt adhesive obtained by adding a petroleum resin in a styrene-isoprene-styrene block copolymer or a styrene-butadiene-styrene block copolymer.

Commercial product of the polyolefin resin based hot-melt adhesive which is proper for the adhesive formed product of the present invention, includes “MORESCOMELT EP-167” produced by MORESCO Corporation.

Commercial product of the polyester resin based hot-melt adhesive which is proper for the adhesive formed product of the present invention, includes “POLYESTAR SP-165” and “POLYESTAR TP-249” produced by The Nippon Synthetic Chemical Industry Co., Ltd.

The melting point (fusion temperature) of the hot-melt adhesive is preferably in the range of 80 to 200°+C., more preferably in the range of 90 to 200° C., and most preferably in the range of 110 to 180° C.

The ferromagnetic material is a substance which can have spontaneous magnetization, even if an external magnetic field does not exist. The ferromagnetic material includes also a ferrimagnetic material. Examples of the ferromagnetic material include iron, cobalt, nickel, ferrite such as barium ferrite and strontium ferrite, rare earth magnetic material such as rare earth cobalt magnet, and Alnico magnet. Among them, ferrite is preferable for controlling the initial magnetism finely.

The ferromagnetic material is preferably powder (called by “magnetic powder” hereinafter). The average particle diameter is preferably in the range of 0.5 to 20 μm, more preferably in the range of 0.5 to 15 μm, and most preferably in the range of 1 to 5 μm.

The mixing ratio of the magnetic powder is preferably in the range of 100 to 400 parts by mass, more preferably in the range of 120 to 350 parts by mass, and most preferably in the range of 150 to 300 parts by mass to 100 parts by mass of the hot-melt adhesive.

For dispersing the magnetic powder in the hot-melt adhesive, it is preferable to mix by heating the hot-melt adhesive and the magnetic powder. The heating temperature is preferably in the range of 110 to 230° C., more preferably in the range of 110 to 200° C., further more preferably in the range of 120 to 180° C., most preferably in the range of 130 to 170° C. Also, the heating temperature is preferably 10° C. or higher than the fusion temperature of the hot-melt adhesive, and more preferably 20° C. to 70° C. higher than the fusion temperature of the hot-melt adhesive. By mixing at the temperature range, the magnetic powder can be homogeneously dispersed in the hot-melt adhesive, and it is also able to prevent the deterioration of the hot-melt adhesive.

In the present invention, the desired properties are exerted in a state that the magnetic powder in the adhesive composition or the adhesive formed product is magnetized. Therefore, the hot-melt adhesive and the magnetized magnetic powder can be mixed, or the hot-melt adhesive and the non-magnetized magnetic powder can be mixed. In the case of the later, the magnetization can be conducted after the mixing. The magnetization can be conducted by well-known methods. When the hot-melt adhesive and the magnetized magnetic powder are mixed by heating, there is a case that the demagnetization is caused. In this case, the magnetization can be conducted.

In the adhesive composition or the adhesive formed product of the present invention, one or more members of a tackifier, an antioxidant, a filler, a dispersing agent or the like can be properly compounded. It is preferable not to compound the foaming agent in the adhesive composition or the adhesive formed product of the present invention to maintain the higher adhesion.

The adhesive composition or the adhesive formed product of the present invention has a shear force of not less than 20 N, preferably not less than 40 N, more preferably not less than 60 N, further more preferably not less than 80 N, and most preferably not less than 100 N after heating (at 150° C. for 10 minutes) bonding.

Herein, the shear force after heating (at 150° C. for 10 minutes) bonding means the shear force measured according to the method of JIS K6850 after forming the adhesive composition or the adhesive formed product into the formed product having a thickness of 250 μm, putting the formed product between two adherends, heating at 150° C. for 10 minutes, and then, returning to the room temperature.

The adhesive composition or the adhesive formed product of the present invention has preferably a viscosity of 5 to 500 Pa·s, and more preferably a viscosity of 15 to 200 Pa·s at 130° C. When the viscosity is in the range, the state that the ferromagnetic material is dispersed in the hot-melt adhesive can be maintained even if the adhesive composition or the adhesive formed product is heated. The measurement of the viscosity is conducted according to the method of JIS K6833, except that the temperature of the sample is 130° C.

The adhesive sheet of the present invention is a sheet composed of the adhesive composition the present invention.

The adhesive sheet or the adhesive formed product of the present invention has a surface magnetic force at room temperature of preferably not less than 20 mT, and more preferably 25 to 100 mT. Herein, the surface magnetic force means a surface magnetic force measured by a Gaussian meter at a distance which is 1 cm apart from the surface of the adhesive sheet or the adhesive formed product of the present invention.

The adhesive sheet or the adhesive formed product of the present invention has a surface magnetic force after heating of preferably less than 5 mT, more preferably less than 3 mT, and most preferably less than 1.5 mT. The lower limitation value of the surface magnetic force is 0 mT.

Herein, the surface magnetic force after heating means the surface magnetic force measured by a Gaussian meter at a distance which is 1 cm apart from the surface of the adhesive sheet or the adhesive formed product after heating the adhesive sheet or the adhesive formed product at 150° C. for 40 minutes, and then, returning to the room temperature.

No particular constraint is imposed on the thickness of the adhesive sheet of the present invention; however, usually the thickness falls preferably within a range from 3 to 500 μm, more preferably within a range from 5 to 400 μm and particularly preferably within a range from 10 to 300 μm.

Thus, the adhesive sheet of the present invention has a strong surface magnetic force at room temperature before heating, and has no tack or has almost no tack at room temperature. Therefore, the adhesive sheet of the present invention can be attached to the adherend composed of metal or the like by only the surface magnetic force. Even if the positioning of the location to be stuck is incorrect, the adhesive sheet of the present invention can move easily and position easily to a correct location. Also, the adhesive sheet of the present invention generates very strong adhesive property by heating, and therefore, can be stuck strongly to the adherend composed of metal or the like. And, the surface magnetic force can be decreased by heating, and therefore, the influence of the magnetic force to the human or electronic equipment can be suppressed as much as possible.

In addition, the adhesive formed product of the present invention has a strong surface magnetic force at room temperature before heating, and has no tack or has almost no tack at room temperature. Therefore, the adhesive formed product of the present invention can be attached to the adherend composed of metal or the like by only the surface magnetic force. Even if the positioning of the location to be stuck is incorrect, the adhesive formed product of the present invention can move easily and position easily to a correct location. Also, the adhesive formed product of the present invention generates very strong adhesive property by heating, and therefore, can be stuck strongly to the adherend composed of the ferromagnetic material. And, the surface magnetic force can be decreased extremely to be small value when the adhesive formed product is heated and then, returned to the room temperature, and therefore, the influence of the magnetic force to the human or electronic equipments can be suppressed as much as possible.

The adhesive sheet of the present invention can be produced by a method which comprises heating the adhesive composition of the present invention to change to fluid state, and applying the fluidized adhesive composition on the surface of a release liner, or a method which comprises extruding the adhesive composition of the present invention in a sheet form by an extruder. The temperature of the adhesive composition at applying is preferably in the range of 130 to 170° C. The extruding temperature of the adhesive composition is preferably in the range of 130 to 170° C.

As the release liner, a release liner provided with the releasing treatment on both surfaces, a release liner provided with the releasing treatment on one surface and the like can be used.

The release liner includes, for example, release liners obtained by applying a release agent such as silicone resin on paper materials such as a glassine paper, a coated paper and a wood free paper, a laminated paper which is laminated with a thermoplastic resin such as polyethylene on the paper material thereof, or a plastic film such as films of polyester resin like polyethylene terephthalate resin, polybutylene terephthalate resin and polyethylene naphthalate resin; or films of polyolefin resin such as polypropylene resin and polyethylene resin.

No particular constraint is imposed on the thickness of the release liner; however, usually the thickness falls preferably within a range from 20 to 200 μm.

The adhesive sheet with a substrate of the present invention comprises a substrate sheet and a layer comprising the adhesive composition, wherein the layer is laminated on one surface or both surfaces of the substrate sheet.

Examples of the substrate sheet include, for example, sheets or films of various synthetic resins of polyolefin resins such as polyethylene resin and polypropylene resin; polyester resins such as polyethylene terephthalate resin, polyethylene naphthalate resin and polybutylene terephthalate resin; polyvinyl chloride resins; polystyrene resins; polyurethane resins; polycarbonate resins; polyamide resins; polyimide resins; fluorine resins and the like. In view of high strength and cheap cost, sheets or films of polyester resins such as polyethylene terephthalate resin are preferable. The substrate sheet can be a single layer or a multiple layers having two or more layers of the same type or different types.

No particular constraint is imposed on the thickness of the substrate sheet; however, usually the thickness falls preferably within a range from 10 to 350 μm, more preferably within a range from 25 to 300 μm, and most preferably within a range from 50 to 250 μm.

On the surface of the substrate sheet, a treatment for improving adhesion can be provided. The treatment for improving adhesion is not limited particularly, but includes, for example, corona discharge treatment.

In the adhesive sheet of the present invention, the layer comprising the adhesive composition is laminated on one surface or both surfaces of the substrate sheet.

No particular constraint is imposed on the thickness of the layer comprising the adhesive composition; however, usually the thickness falls preferably within a range from 3 to 500 μm, more preferably within a range from 5 to 400 μm, most preferably within a range from 10 to 300 μm.

The adhesive sheet having the layer comprising the adhesive composition described above on one surface or both surfaces of the substrate sheet, can be produced by a method which comprises applying the heated adhesive composition described above on one surface or both surfaces of the substrate sheet, or a method which comprises extruding the heated adhesive composition described above in a sheet form by an extruder, and then, laminating the extruded sheet on one surface or both surfaces of the substrate sheet. The temperature of the adhesive composition at applying is preferably in the range of 130 to 170° C. The extruding temperature of the adhesive composition is preferably in the range of 130 to 170° C.

In addition, the adhesive sheet with a substrate can be produced by forming the layer comprising the adhesive composition of the present invention on the surface of the release liner described above, and then, laminating the substrate sheet on the surface thereof.

When the layer comprising the adhesive composition described above is formed on one surface of the substrate sheet in the adhesive sheet with the substrate of the present invention, a pressure-sensitive adhesive layer can be formed on the other surface of the substrate sheet.

The pressure-sensitive adhesive has a tack at room temperature and includes, for example, natural rubber-based pressure-sensitive adhesives, synthetic rubber-based pressure-sensitive adhesives, acrylic resin-based pressure-sensitive adhesives, polyvinylether resin-based pressure-sensitive adhesives, urethane resin-based pressure-sensitive adhesives and silicone resin-based pressure-sensitive adhesives.

No particular constraint is imposed on the thickness of the pressure-sensitive adhesive layer; however, usually the thickness after drying falls preferably within a range from 3 to 150 μm, more preferably within a range from 5 to 100 μm and particularly preferably within a range from 10 to 60 μm.

The formation of pressure-sensitive adhesive layer on the other surface of the substrate sheet can be conducted by applying the pressure-sensitive adhesive on the other surface of the substrate sheet, and optionally drying.

Application methods of the pressure-sensitive adhesive composition described above on the substrate sheet include conventional known methods such as, for example, a bar coating method, a knife coating method, a roll coating method, a blade coating method, a die coating method, a gravure coating method and a curtain coating method.

The drying is preferable to carry out usually at 20 to 150° C.

The adhesive sheet of the present invention can be used for bonding and fixturing an article such as component on the surface of the adherend composed of metal or the like, and also, can be used for bonding and fixturing between adherends composed of metal. The metal includes materials exhibiting ferromagnetic property such as iron and nickel.

The adhesive sheet of the present invention has magnetic force at room temperature before heating, and therefore, can be used for applying to various articles which can be held by magnetic force. In addition, even if the surface of the article to be an adherend is smeared with oil, the adhesive sheet of the present invention can be held by magnetic force and stuck by heating. The adhesive sheet of the present invention is preferably heated after holding on the article by magnetic force, and cooled after heating. The heating temperature is preferably in the range of 110 to 200° C., more preferably in the range of 120 to 180° C., and most preferably in the range of 130 to 170° C.

The adhesion after heating (at 150° C. for 10 minutes) to the surface of the stainless steel plate of the adhesive sheet of the present invention is preferably not less than 60 N/25 mm, and more preferably not less than 65 N/25 mm. Further, the adhesion to the surface smeared with oil of a stainless steel plate smeared with oil on the surface is preferably not less than 55 N/25 mm, and more preferably not less than 60 N/25 mm.

The adhesive formed product of the present invention can be used for bonding between components composed of the material exhibiting ferromagnetic property. The component composed of the material exhibiting ferromagnetic property includes components composed of a material containing iron, cobalt, nickel or the like. Concretely, the component composed of the material exhibiting ferromagnetic property includes components for automobiles such as a plate for stopping up the hole in steel plate for a door or a body, and a reinforcing component of automobile body.

The adhesive formed product of the present invention can be formed in a specific shape which is needed for bonding between components. Examples of the shape of the adhesive formed product include sheet figures, plate figures, column figures and pole figures, having various shapes such as polygons such as triangle, quadrangle, pentagon, hexagon, and octagon, circular like shapes such as circle and ellipse, and ring shapes obtained by removing the center portion thereof.

The thickness of the sheet figures is usually preferably in the range of more than 0.5 mm and not more than 20 mm, and more preferably in the range of 1 to 10 mm.

The adhesive formed product of the present invention can be produced by a method which comprises heating the mixture comprising hot-melt adhesive and the ferromagnetic material to change to fluid state, applying the fluidized adhesive composition on the surface of a release liner, and then, cutting in a desired shape, or a method which comprises molding the mixture comprising hot-melt adhesive and the ferromagnetic material in a desired shape by an injection molding machine. The temperature of the mixture comprising hot-melt adhesive and the ferromagnetic material at applying is preferably in the range of 130 to 170° C. The injection molding temperature of the mixture comprising hot-melt adhesive and the ferromagnetic material is preferably in the range of 130 to 170° C.

As the release liner, a release liner provided with the releasing treatment on both surfaces, a release liner provided with the releasing treatment on one surface and the like can be used.

The release liner includes release liners obtained by applying a release agent such as silicone resin on paper materials such as a glassine paper, a coated paper and a wood free paper, a laminated paper which is laminated with a thermoplastic resin such as polyethylene on the paper material thereof, or plastic film such as films of polyester resin like polyethylene terephthalate resin, polybutylene terephthalate resin and polyethylene naphthalate resin; or films of polyolefin resin such as polypropylene resin and polyethylene resin.

No particular constraint is imposed on the thickness of the release liner; however, usually the thickness falls preferably within a range from 20 to 200 μm.

With respect to the bonding between components with the adhesive formed product of the present invention, for example, if the bonding between components is conducted between surfaces to be bonded of two components, two components can be bonded by putting the adhesive formed product in sheet or plate figure having a shape of the surface to be bonded between the surfaces to be bonded of the two components, and then, heating. Further, if for stopping up the hole in a bored plate, a plate for stopping up the hole which has a size slightly bigger than the size of the hole is bonded, the bored plate and the plate for stopping up the hole can be bonded by covering the hole in the plate with the plate for stopping up to stop up the hole, covering the plate for stopping up the hole and the peripheral portion thereof to stop up the hole with the sheet adhesive formed product having a size slightly bigger than the size of the plate for stopping up the hole, holding the plate for stopping up the hole by means of magnetic force, and then, heating. The sheet adhesive formed product can have a ring shape by removing the center portion.

In addition, the hole in the plate can be stopped up by preliminary holding the sheet adhesive formed product on the plate for stopping up the hole, and then, stopping up the hole in the plate with the plate for stopping up the hole held with the sheet adhesive formed product.

Since the sheet adhesive formed product has a shape slightly bigger than the shape of the plate for stopping up the hole, the sheet adhesive formed product is extended beyond the plate for stopping up the hole. The width of the portion extending beyond the plate for stopping up the hole is not limited particularly, but is preferably in the range of 3 to 30 mm, and more preferably in the range of 5 to 20 mm.

The adhesive formed product of the present invention has magnetic force at room temperature before heating, and therefore, can be used for applying to various components which are ferromagnetic components. The adhesive formed product of the present invention is preferably heated after holding on the component by means of magnetic force, and cooled after heating. The heating temperature is preferably in the range of 110 to 200° C., more preferably in the range of 120 to 180° C., and most preferably in the range of 130 to 170° C.

### EXAMPLES

Hereinafter, specific description will be made on the present invention with reference to Examples. However, the present invention is not limited at all by these Examples.

### Example of Production of Adhesive Composition and Adhesive Sheet

### Example 1

(1) Preparation of an Adhesive Composition

Into a mixing machine(manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of polyester resin based hot-melt adhesive (manufactured by The Nippon Synthetic Chemical Industry Co., Ltd., trade name “POLYESTAR SP-165”, fusion temperature of 130° C.) were charged to mix. And then, the mixture was heated at 160° C., and mixed for 40 minutes to obtain an adhesive composition.

(2) Production of an Adhesive Sheet

The adhesive composition prepared in (1) described above was extruded from a die at an extruding temperature of 160° C. by an extruder to form an adhesive layer having a thickness of 250 μm, and the extruded adhesive layer was laminated on a surface of a release liner of a polyethylene terephthalate resin sheet in which a surface was treated with silicone (manufactured by LINTEC Corporation, trade name “SP-PET 100(T)”, thickness of 100 μm). Immediately after the lamination, a substrate sheet (a polyethylene terephthalate sheet produced by TORAY INDUSTRIES, INC., trade name “LUMIRROR #100T60”, having a thickness of 100 μm) was laminated on the surface of the adhesive layer, and the adhesive layer was cooled to room temperature. Next, by using a high tension condenser magnetizing and demagnetizing electric power unit (manufactured by MAGNETICLABO Co., Ltd., trade name “PC-2520ND”), the magnetization was conducted under the condition of voltage of 500 V and electric current of 8 kA to form an adhesive sheet with a substrate.

By using the obtained adhesive sheet with a substrate, the following evaluating tests were conducted. The results are shown in Table 1. The adhesive sheet with a substrate had high adhesion to the surface smeared with oil, and could decrease the surface magnetic force to small amount by heating. In addition, the adhesive sheet with a substrate was superior in solvent resistance and gasoline resistance.

### Measurement of Viscosity of the Adhesive Composition

The viscosity of the adhesive composition was measured according to JIS K6833, except that the temperature of the adhesive composition was 130° C.

### Shear Force

From the obtained adhesive sheet with a substrate, the release liner was removed, and the adhesive layer was stuck to a stainless steel plate (having a thickness of 3 mm) at room temperature, and then, was heated at 150° C., for 10 minutes and returned to the room temperature. And then, the shear force was measured according to JIS K6850. In the measurement, a test speed was 300 mm/min.

### Magnetic Force

From the obtained adhesive sheet with a substrate, the release liner was removed, and a magnetic force (mT) at room temperature before heating was measured by a Gaussian meter (manufactured by TOYO Corporation., trade name “5080 type HANDY GAUS METER”) at a distance which is 1 cm apart from the surface of the adhesive layer. In addition, the adhesive sheet with a substrate was heated at 150° C., for 40 minutes and returned to the room temperature. And then, from the obtained adhesive sheet with a substrate, the release liner was removed, and a magnetic force (mT) at room temperature after heating was measured by a Gaussian meter at a distance which is 1 cm apart from the surface of the adhesive layer.

### Adhesion

From the obtained adhesive sheet with a substrate, the release liner was removed, and the adhesive sheet with a substrate was held (attached) on a stainless steel plate at room temperature. After 20 minutes from the holding (i), the held adhesive sheet with a substrate was heated at 150° C. for 10 minutes, and then, returned to room temperature (ii). And then, the adhesion was measured according to JIS 20237.

Also, in the same method, the adhesive sheet with a substrate was held (attached) at room temperature on a surface of a stainless steel plate smeared with oil (manufactured by TOYOTA MOTER CORPORATION, trade name “TOYOTA JUNSEI BLAKEFLUID 2500H”) on the surface. The held adhesive sheet with a substrate was heated at 150° C. for 10 minutes, and then, returned to room temperature. And then, the adhesion was measured according to JIS Z0237.

### Solvent Resistance

Ten g of the adhesive composition was taken from the adhesive sheet with a substrate, and was immersed into 100 g of toluene for 30 minutes. And then, the existence or non-existence of elution of the adhesive composition into toluene was observed by visual, and the solvent resistance was evaluated according to the following standard.
◯: non-existence of elution
×: existence of elution

### Gasoline Resistance

Ten g of the adhesive composition was taken from the adhesive sheet with a substrate, and was immersed into 100 g of gasoline for 30 minutes. And then, the existence or non-existence of elution of the adhesive composition into gasoline was observed by visual, and the gasoline resistance was evaluated according to the following standard.
◯: non-existence of elution
×: existence of elution

### Example 2

(1) Preparation of an Adhesive Composition

Into a mixing machine(manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of polyolefin resin based hot-melt adhesive (manufactured by MORESCO Corporation, trade name “MORESCOMELT EP-167”, fusion temperature of 100° C.) were charged to mix. And then, the mixture was heated at 160° C., and mixed for 40 minutes to obtain an adhesive composition.

(2) Production of an Adhesive Sheet

The adhesive composition prepared in (1) described above was extruded from a die at an extruding temperature of 160° C. by an extruder to form an adhesive layer having a thickness of 250 μm, and the extruded adhesive layer was laminated on a surface of a release liner of a polyethylene terephthalate resin sheet in which a surface was treated with silicone (manufactured by LINTEC Corporation, trade name “SP-PET 100(T)”, thickness of 100 μm). Immediately after the lamination, a substrate sheet (a polyethylene terephthalate sheet produced by TORAY INDUSTRIES, INC., trade name “LUMIRROR #100T60”, having a thickness of 100 μm) was laminated on the surface of the adhesive layer, and the adhesive layer was cooled to room temperature. Next, by using a high tension condenser magnetizing and demagnetizing electric power unit (manufactured by MAGNETICLABO Co., Ltd., trade name “PC-2520ND”), the magnetization was conducted under the condition of voltage of 500 V and electric current of 8 kA to form an adhesive sheet with a substrate. The adhesive sheet with a substrate had high adhesion to the surface smeared with oil, and could decrease the surface magnetic force to small amount by heating. In addition, the adhesive sheet with a substrate was superior in solvent resistance and gasoline resistance.

By using the obtained adhesive sheet with a substrate, the above described evaluating tests were conducted. The results are shown in Table 1.

### Example 3

An adhesive sheet was prepared in the same method as described in Example 1, except that a polyester resin based hot-melt adhesive (manufactured by The Nippon Synthetic Chemical Industry Co., Ltd., trade name “POLYESTAR TP-249”, fusion temperature of 100° C.) was used as the hot-melt adhesive.

By using the obtained adhesive sheet, the above described evaluating tests were conducted. The results are shown in Table 1.

### Example 4

An adhesive sheet was prepared in the same method as described in Example 1, except that a barium ferrite powder (having an average particle diameter of 2 μm) was used as the magnetic powder.

By using the obtained adhesive sheet, the above described evaluating tests were conducted. The results are shown in Table 1.

### Comparative Example 1

Into a mixing machine(manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of rubber based pressure-sensitive adhesive (manufactured by MORESCO Corporation, trade name “MORESCOMELT TY-70”) were charged to mix. And then, the mixture was heated at 120 V, and mixed for 40 minutes to obtain an adhesive composition.

An adhesive sheet was prepared in the same method as described in Example 1, by using the obtained adhesive composition.

By using the obtained adhesive sheet, the above described evaluating tests were conducted. The results are shown in Table 1.

TABLE 1

| | | | | | | Compara- |
|---|---|---|---|---|---|---|
| | | Example | | | | tive |
| | | 1 | 2 | 3 | 4 | Example 1 |
| Ingredients of composition | | | | | | |
| Strontium ferrite powder | | 200 | 200 | 200 | | 200 |
| Barium ferrite powder | | | | | 200 | |
| Polyester resin based hot- | | 100 | — | 100 | 100 | — |
| melt adhesive | | | | | | |
| Polyolefin resin based hot- | | — | 100 | — | — | — |
| melt adhesive | | | | | | |
| Rubber based pressure- | | — | — | — | — | 100 |
| sensitive adhesive | | | | | | |
| Results of evaluation | | | | | | |
| Viscosity at 130° C. (Pa · s) | | 120 | 110 | 400 | 120 | 110 |
| Shear | To the surface | 120 | 100 | 150 | 120 | 15 |
| force (N) | of stainless | | | | | |
| | steel plate | | | | | |
| Magnetic force at room | | 30 | 30 | 30 | 23 | 30 |
| temperature before heating (mT) | | | | | | |
| Magnetic force at room | | 0 | 0 | 0 | 0 | 0 |
| temperature after heating (mT) | | | | | | |
| Adhesion | To stainless | 1 | 1 | 1 | 1 | 50 |
| (N/25 mm) | steel plate (i) | | | | | |
| | To stainless | 80 | 65 | 85 | 80 | 100 |
| | steel plate (ii) | | | | | |
| | To surface | 60 | 50 | 50 | 60 | 30 |
| | smeared with oil | | | | | |

| | | | | | |
|---|---|---|---|---|---|
| Solvent resistance | ◯ | ◯ | ◯ | ◯ | X |
| Gasoline resistance | ◯ | ◯ | ◯ | ◯ | X |

The adhesive sheet of the present invention can be used for bonding between adherends composed of metal or the like, or bonding and fixturing the other component to the adherend composed of metal or the like. Also, the adhesive sheet of the present invention is superior in sticking application to the surface of the adherend smeared with oil on the surface, can obtain strong adhesion by heating, and therefore, and can be used instead of a bolt or a screw as means of bonding.

### Example of Production of Adhesive Formed Product

### Example 5

(1) Preparation of a Mixture of Hot-Melt Adhesive and Magnetic Powder

Into a mixing machine(manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of polyester resin based hot-melt adhesive (manufactured by The Nippon Synthetic Chemical Industry Co., Ltd., trade name “POLYESTAR SP-165”, fusion temperature of 130° C.) were charged to mix. And then, the mixture was heated at 160 and mixed for 30 minutes to obtain a mixture of a hot-melt adhesive and a magnetic powder.

(2) Production of an Adhesive Formed Product

The mixture of a hot-melt adhesive and a magnetic powder prepared in (1) described above was injection-molded at an injection molding temperature of 160° C., by an injection molding machine to form a ring circular plate (having a thickness of 5 mm, a diameter of outside circumference of 75 mm, and a diameter of inside circumference of 60 mm). Next, by using a high tension condenser magnetizing and demagnetizing electric power unit (manufactured by MAGNETICLABO Co., Ltd., trade name “PC-2520ND”), the magnetization was conducted under the condition of voltage of 500 V and electric current of 8 kA to form an adhesive formed product.

By using the obtained adhesive formed product, the following evaluating tests were conducted. The results are shown in Table 2.

### Viscosity of the Mixture at 130° C.

The viscosity of the adhesive composition was measured according to JIS K6833, except that the temperature of the mixture was 130° C.

### Shear Force

The mixture of a hot-melt adhesive and a magnetic powder was extruded at an extruding temperature of 160° C. by an extruder to form a mixture layer having a thickness of 250 μm, and the extruded mixture layer was laminated on a polyethylene terephthalate resin film (a polyethylene terephthalate sheet produced by TORAY INDUSTRIES, INC., trade name “LUMIRROR #100T60”), and the extruded mixture layer was cooled to room temperature. Next, by using a high tension condenser magnetizing and demagnetizing electric power unit (manufactured by MAGNETICLABO Co., Ltd., trade name “PC-2520ND”), the magnetization was conducted under the condition of voltage of 500 V and electric current of 8 kA.

The mixture layer was stuck to a stainless steel plate (having a thickness of 3 mm) at room temperature, and then, was heated at 150° C., for 10 minutes and returned to the room temperature. And then, the shear force was measured according to JIS K6850. In the measurement, a test speed was 300 mm/min.

### Magnetic Force

A magnetic force (mT) at room temperature before heating was measured by a Gaussian meter (manufactured by TOYO Corporation., trade name “5080 type HANDY GAUS METER”) at a distance which is 1 cm apart from the surface of the obtained adhesive formed product. In addition, the obtained adhesive formed product was heated at 150° C., for 40 minutes and returned to the room temperature. And then, a magnetic force (mT) at room temperature after heating was measured by a Gaussian meter at a distance which is 1 cm apart from the surface of the adhesive formed product.

### Solvent Resistance

Ten g of the adhesive composition was taken from the adhesive sheet with a substrate, and was immersed into 100 g of toluene for 30 minutes. And then, the existence or non-existence of elution of the adhesive composition into toluene was observed by visual, and the solvent resistance was evaluated according to the following standard.
◯: non-existence of elution
×: existence of elution

### Gasoline Resistance

Ten g of the adhesive composition was taken from the adhesive sheet with a substrate, and was immersed into 100 g of gasoline for 30 minutes. And then, the existence or non-existence of elution of the adhesive composition into gasoline was observed by visual, and the resistance was evaluated according to the following standard.
◯: non-existence of elution
×: existence of elution

### Example 6

(1) Preparation of a Mixture of Hot-Melt Adhesive and Magnetic Powder

Into a mixing machine(manufactured by PRIMIX Corporation, trade name “T.K. HYBISMIX 2P-1”), 200 parts by mass of strontium ferrite powder (having an average particle diameter of 2 μm) as magnetic powder, and 100 parts by mass of polyolefin resin based hot-melt adhesive (manufactured by MORESCO Corporation, trade name “MORESCOMELT EP-167”, fusion temperature of 100° C.) were charged to mix. And then, the mixture was heated at 160° C., and mixed for 30 minutes to obtain a mixture of a hot-melt adhesive and a magnetic powder.

(2) Production of an Adhesive Formed Product

The mixture of a hot-melt adhesive and a magnetic powder prepared in (1) described above was injection-molded at an injection molding temperature of 160° C. by an injection molding machine to form a ring circular plate (having a thickness of 5 mm, a diameter of outside circumference of 75 mm, and a diameter of inside circumference of 60 mm). Next, the magnetization was conducted in the same method as described in Example 5.

By using the obtained adhesive formed product, the above described evaluating tests were conducted. The results are shown in Table 2.

### Comparative Example 2

Into a mixing machine(manufactured by PRIMIX Corporation, trade name “T.K. HYBISMIX 2P-1”), 200 parts by mass of strontium ferrite powder (having an average particle diameter of 2 rim) as magnetic powder, and 100 parts by mass of rubber based pressure-sensitive adhesive (manufactured by MORESCO Corporation, trade name “MORESCOMELT TY-70”) were charged to mix. And then, the mixture was heated at 110 and mixed for 30 minutes to obtain an adhesive composition.

An adhesive formed product was prepared in the same method as described in Example 5, by using the obtained adhesive composition.

By using the obtained adhesive formed product, the above described evaluating tests were conducted. The results are shown in Table 2.

TABLE 2

| | |
|---|---|
| Example | Comparative |

| | 5 | 6 | Example 2 |
|---|---|---|---|
| Ingredients of | | | |
| composition | | | |
| Strontium ferrite powder | 200 | 200 | 200 |
| Polyester resin based hot- | 100 | — | — |
| melt adhesive | | | |
| Polyolefin resin based | — | 100 | — |
| hot-melt adhesive | | | |
| Rubber based pressure- | — | — | 100 |
| sensitive adhesive | | | |
| Result of evaluation | | | |
| Viscosity at 130° C. | 120 | 110 | 110 |
| (Pa · S) | | | |
| Shear force (N) to | 120 | 100 | 15 |
| surface of stainless | | | |
| steel plate | | | |
| Magnetic force at room | 30 | 30 | 30 |
| temperature before | | | |
| heating (mT) | | | |
| Magnetic force at room | 0 | 0 | 0 |
| temperature after heating | | | |
| (mT) | | | |
| Solvent resistance | ◯ | ◯ | X |
| Chemical resistance | ◯ | ◯ | X |

### Bonding Between Components

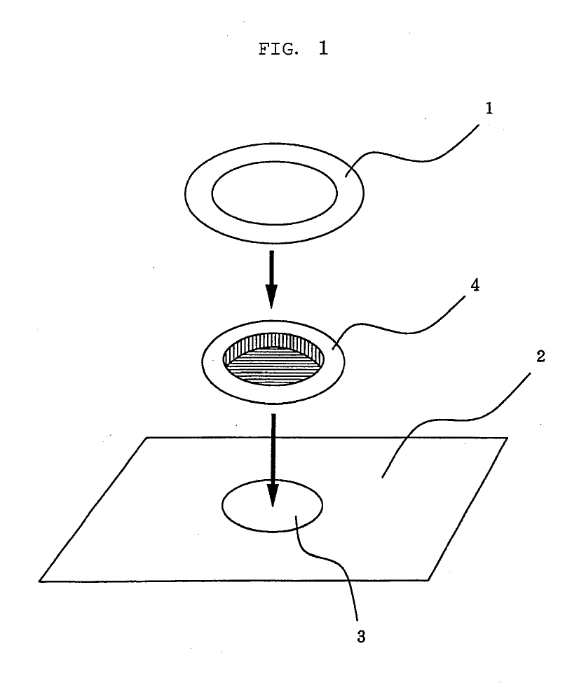

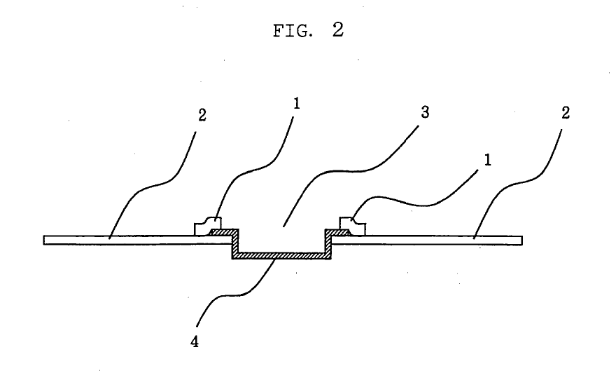

As shown in FIG. 1, for stopping up the hole 3 in a bored steel plate for automobile body 2 (having a hole 3 of circle shape having a diameter of 50 mm), a steel plate for stopping up the hole 4 (having a circle shape having a diameter of inside circumference of 49 mm, and a diameter of outside circumference of 65 mm, wherein the outside circumference had an indentation, having a thickness of 2 mm,) which has a size slightly bigger than the shape of the hole 3, was covered on the hole 3. And, on the steel plate for stopping up the hole 4, the adhesive formed product 1 (having a ring circular plate) obtained by Example 5, Example 6 or Comparative Example 2 was covered so as to extend uniformly from the peripheral edge of the steel plate for stopping up the hole 4, and contacted to the both surfaces of the steel plate for stopping up the hole 4 and the steel plate for automobile body 2 around the peripheral of the steel plate for stopping up the hole 4 to hold by means of magnetic force. The cross section figure was shown in FIG. 2.

And then, the bored steel plate for automobile body 2 and the steel plate for stopping up the hole 4 covered with the adhesive formed product 1 was heated at 150 for 40 minutes, and cooled to room temperature to bond.

The steel plate for automobile body and the steel plate for stopping up the hole bonded by using the adhesive formed product of Example 5, Example 6, were bonded strongly, and did not have magnetic force. On the other hand, when slight force (shear force) was added to the steel plate for automobile body and the steel plate for stopping up the hole bonded by using the adhesive formed product of Comparative Example 2, the steel plate for stopping up the hole was peeled from the steel plate for automobile body.

The adhesive formed product of the present invention can be used for bonding between components composed of a ferromagnetic material. Also, the adhesive formed product of the present invention is superior in the sticking application on a surface of a component smeared with oil on the surface, further can obtain a strong adhesion by heating, and therefore, can be used instead of a bolt or a screw as means of bonding.

1. An adhesive composition, comprising:
a mixture of a hot-melt adhesive and a ferromagnetic material,
wherein the adhesive composition has a shear force of not less than 20 N after heating bonding at 150° C. for 10 minutes.

2. The adhesive composition as claimed in claim 1, wherein the adhesive composition has a viscosity of 5 to 500 Pa·s at 130° C.

3. The adhesive composition as claimed in claim 1, wherein the hot-melt adhesive is one of a polyester resin based hot-melt adhesive and a polyolefin resin based hot-melt adhesive.

4. An adhesive sheet which comprises the adhesive composition as claimed in claim 1 and has a surface magnetic force of not less than 20 mT and a surface magnetic force after heating, 150° C. for 40 minutes, of less than 5 mT.

5. The adhesive sheet as claimed in claim 4, wherein the adhesive sheet can be applied to a surface of an adherend smeared with oil on the surface.

6. An adhesive sheet with a substrate which comprises a substrate sheet and a layer comprising the adhesive composition as claimed in claim 1 , wherein the layer is laminated on one surface or both surfaces of the substrate sheet.

7. An adhesive formed product comprising:
a mixture of a hot-melt adhesive and a ferromagnetic material,
wherein the adhesive formed product has a shear force of not less than 20 N after heating bonding at 150° C. for 10 minutes, and
wherein the adhesive formed product is used for bonding between components composed of a material exhibiting ferromagnetism.

8. The adhesive formed product as claimed in claim 7, wherein a shear force of the mixture after heating bonding, at 150° C. for 10 minutes, is not less than 50 N.

9. The adhesive formed product as claimed in claim 7, wherein the mixture of the hot-melt adhesive and the ferromagnetic material has a viscosity of 5 to 500 Pa·s at 130° C.

10. The adhesive formed product as claimed in claim 7, wherein the adhesive formed product has a surface magnetic force of not less than 20 mT and a surface magnetic force after heating, 150° C. for 40 minutes, of less than 5 mT.

11. The adhesive composition as claimed in claim 2, wherein the hot-melt adhesive is one of a polyester resin based hot-melt adhesive and a polyolefin resin based hot-melt adhesive.

12. An adhesive sheet which comprises the adhesive composition as claimed in claim 2, and has a surface magnetic force of not less than 20 mT and a surface magnetic force after heating, at 150° C. for 40 minutes, of less than 5 mT.

13. An adhesive sheet which comprises the adhesive composition as claimed in claim 3, and has a surface magnetic force of not less than 20 mT and a surface magnetic force after heating, at 150° C. for 40 minutes, of less than 5 mT.

14. An adhesive sheet which comprises the adhesive composition as claimed in claim 11, and has a surface magnetic force of not less than 20 mT and a surface magnetic force after heating, at 150° C. for 40 minutes, of less than 5 mT.

15. The adhesive sheet as claimed in claim 12, wherein the adhesive sheet can be applied to a surface of an adherend smeared with oil on the surface.

16. The adhesive sheet as claimed in claim 13, wherein the adhesive sheet can be applied to a surface of an adherend smeared with oil on the surface.

17. The adhesive sheet as claimed in claim 14, wherein the adhesive sheet can be applied to a surface of an adherend smeared with oil on the surface.

18. An adhesive sheet with a substrate which comprises a substrate sheet and a layer comprising the adhesive composition as claimed in claim 2, wherein the layer is laminated on one surface or both surfaces of the substrate sheet.

19. An adhesive sheet with a substrate which comprises a substrate sheet and a layer comprising the adhesive composition as claimed in claim 3, wherein the layer is laminated on one surface or both surfaces of the substrate sheet.

20. An adhesive sheet with a substrate which comprises a substrate sheet and a layer comprising the adhesive composition as claimed in claim 11, wherein the layer is laminated on one surface or both surfaces of the substrate sheet.

21. The adhesive formed product as claimed in claim 8, wherein the mixture of the hot-melt adhesive and the ferromagnetic material has a viscosity of 5 to 500 Pa·s at 130° C.

22. The adhesive formed product as claimed in claim 8, wherein the adhesive formed product has a surface magnetic force of not less than 20 mT and a surface magnetic force after heating, 150° C. for 40 minutes, of less than 5 mT.

23. The adhesive formed product as claimed in claim 9, wherein the adhesive formed product has a surface magnetic force of not less than 20 mT and a surface magnetic force after heating, 150° C. for 40 minutes, of less than 5 mT.

24. The adhesive formed product as claimed in claim 21, wherein the adhesive formed product has a surface magnetic force of not less than 20 mT and a surface magnetic force after heating, 150° C. for 40 minutes, of less than 5 mT.
